(19) United States
(12) Patent Application Publication
(10) Pub. No.: US 2006/0054061 A1
(43) Pub. Date: Mar. 16, 2006

(54) Bacteria and mold resistant wallboard

(76) Inventor: Douglas H. Ruddick, Beaver Falls, PA (US)

Correspondence Address: Lara A. Northrop;Pietragallo, Bosick & Gordon LLP, One Oxford Centre, 38th Floor, 301 Grant Street, Pittsburgh, PA, 15219, US

(21) Appl. No.: 11/225,333

(22) Filed: Sep. 13, 2005

Related U.S. Application Data
(60) Provisional application No. 60/609,286, filed on Sep. 13, 2004.

(51) Int. Cl. C04B 28/14

(52) U.S. Cl. 106/778

(57) ABSTRACT

A wallboard comprising a gypsum layer and a cellulose-based layer comprising zinc oxide covering at least a portion of a surface of the gypsum layer is disclosed. The zinc oxide can be impregnated into the cellulose-based layer, or coated on a surface of the cellulose-based layer. The zinc oxide can also be incorporated into the gypsum layer. The zinc oxide can have a specific surface of from 2 m²/gram to 100 m²/gram. A method of making gypsum wallboard is also disclosed.

### CROSS REFERENCE TO RELATED APPLICATION

This application claims the benefit of U.S. Provisional Application No. 60/609,286 filed Sep. 13, 2004, which is incorporated herein by reference.

### FIELD OF THE INVENTION

The present invention relates to wallboard, and more particularly, relates to wallboard comprising a gypsum layer and/or cellulose-based layers comprising zinc oxide.

### BACKGROUND INFORMATION

Wallboard, or gypsum board, is commonly used in residential and commercial construction. One of the major issues of public health in recent years has been the increase in toxic mold found growing on wallboard and/or cellulose-based coverings of wallboard. Toxic molds are responsible for sick building syndrome which can render residential and commercial structures inhabitable. A particularly concerning toxic mold is Stachybotrys chartarum which forms toxic spores and mycotoxins that have been implicated in severe health problems, including death. Stachybotrys differs from everyday shower mold in that it feeds primarily on cellulose-based materials, such as wallboard and wallboard coverings, and is very difficult to clean and/or remove.

In residential and commercial construction, chronic or acute toxic molds can grow when leaks occurs or when the ambient moisture increases and the wallboard or cellulose-based covering of wallboard becomes wet enough to support the growth of Stachybotrys. Typically, the exterior side of wallboard is exposed and faces into a house or office room interior. This surface can be easily cleaned. However, the interior side of wallboard is typically hidden within the walls of a building and cannot be viewed by residents. This surface is not easily accessible and is almost never cleaned. The growth of harmful bacteria, fungus and toxic mold on the interior side of wallboard and cellulose-based wallboard coverings may only become evident upon demolition.

Traditional methods of preventing bacterial and fungal growth on building materials include removing contaminated building materials, reducing ambient temperature and moisture, and treating the building material with a sodium hypochlorite, such as household bleach, to inhibit growth. In certain geographic areas, reduction of the relative humidity and free moisture present in the atmosphere is extremely cost prohibitive. Furthermore, building materials treated solely with a sodium hypochlorite have been found to reduce bacterial and mold growth for only a limited duration unless relative moisture is also reduced. Accordingly, traditional means of inhibiting bacterial and mold growth on wallboard and cellulose-based wallboard coverings have been met with only limited success and require significant capital expenditures to maintain.

Once toxic molds such as Stachybotrys become established, remediation is very expensive and difficult and many experts feel it can never be accomplished completely. Some reports even indicate that completely burning an affected structure does not destroy toxic mold because the burning temperature is not hot enough to fully kill the harmful organisms. Accordingly, a need remains for a wallboard and cellulose-based wallboard covering that reduce the formation of bacteria, fungus and/or toxic mold.

### SUMMARY OF THE INVENTION

Wallboard in accordance with the present invention can comprise a gypsum layer and a cellulose-based layer comprising zinc oxide. The cellulose-based layer can cover at least a portion of a surface of the gypsum layer. Two cellulose-based layers can cover two surfaces of the gypsum layer. The zinc oxide can be impregnated into the cellulose-based layer, or coated on a surface of the cellulose-based layer. The zinc oxide can also be incorporated into the gypsum layer.

An aspect of the present invention is to provide wallboard comprising a gypsum layer, and a cellulose-based layer comprising zinc oxide covering at least a portion of a surface of the gypsum layer.

Another aspect of the present invention is to provide wallboard comprising a gypsum layer comprising zinc oxide.

Another aspect of the present invention is to provide a method of making gypsum wallboard comprising incorporating zinc oxide particles having a specific surface of from 2 m²/gram to 100 m²/gram with a cellulose-based layer, and applying the cellulose-based layer over at least a portion of an outer surface of a gypsum layer.

A further aspect of the present invention is to provide a method of making gypsum wallboard comprising incorporating zinc oxide particles having a surface area of from 2 m²/gram to 100 m²/gram with a gypsum layer material.

These and other aspects of the present invention will be more fully understood following a review of this specification and drawings.

### BRIEF DESCRIPTION OF THE DRAWINGS

FIG. 1 is a schematic side view of wallboard and a cellulose-based covering comprising zinc oxide in accordance with an embodiment of the present invention.

FIG. 2 is a schematic side view of wallboard comprising zinc oxide in accordance with an embodiment of the present invention.

FIG. 3 is a schematic side view of wallboard comprising zinc oxide and a cellulose-based covering comprising zinc oxide in accordance with an embodiment of the present invention.

FIG. 4 is a pictorial representation of the front side of standard wallboard exposed to moisture and Stachybotrys.

FIG. 5 is a pictorial representation of the back side of standard wallboard exposed to moisture and Stachybotrys.

FIG. 6 is a pictorial representation of the front side of standard wallboard sprayed with zinc oxide and exposed to moisture and Stachybotrys, in accordance with an embodiment of the present invention.

FIG. 7 is a pictorial representation of the back side of standard wallboard sprayed with zinc oxide and exposed to moisture and Stachybotrys, in accordance with an embodiment of the present invention.

FIG. 8 is a pictorial representation of the front side of standard wallboard contacted with a traditional primer and exposed to moisture and Stachybotrys.

FIG. 9 is a pictorial representation of the back side of standard wallboard contacted with a traditional primer and exposed to moisture and Stachybotrys.

FIG. 10 is a pictorial representation of the front side of standard wallboard contacted with a conventional primer containing zinc oxide and exposed to moisture and Stachybotrys.

FIG. 11 is a pictorial representation of the back side of standard wallboard contacted with a primer containing zinc oxide and exposed to moisture and Stachybotrys.

### DETAILED DESCRIPTION

The present invention discloses a wallboard material comprising zinc oxide that exhibits bacteriastat and/or moldistat properties. As used herein, the term “moldistat” means the ability to reduce the growth of mold. As used herein, the term “bacteriastat” means the ability to reduce the growth of bacteria.

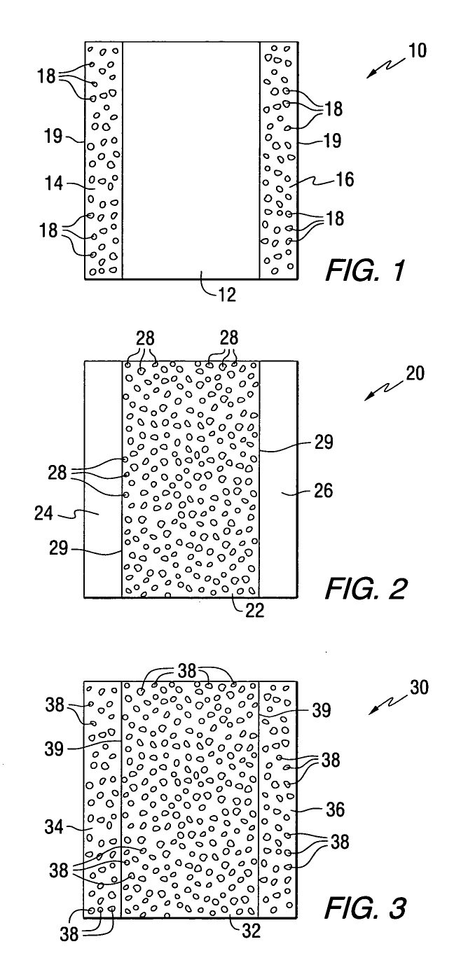

As shown in FIG. 1, wallboard 10, also known as gypsum board or sheetrock, comprises a gypsum layer 12 sandwiched between a first cellulose-based layer 14 and a second cellulose-based layer 16. As used herein, the term “gypsum layer” means a layer comprising a substantial amount of gypsum, for example, at least 50 weight percent gypsum. The gypsum layer can comprise a gypsum layer material such as calcium sulfate dihydrate that has been milled, hydrated and heated into a continuous slab. Other materials such as reinforcing and strengthening agents can also be added to the gypsum layer. Example reinforcing and strengthening agents include chemical bonding agents, and polymeric, cellulose-based and/or metal fibers. The gypsum layer can have any conventional suitable dimensions and thicknesses suitable for use as a sheet building material.

The first and second cellulose-based layers 14 and 16 can comprise a thick paper, such as kraft paper or other cellulose-based facing material including cardboard and/or fiberglass. In one embodiment, the first cellulose-based layer 14 comprises a thick bleached paper and the second cellulose-based layer 16 comprises an unbleached or partially unbleached kraft paper. The first and second cellulose-based layers 14 and 16 can have any suitable thickness, as is conventionally known, and can have any suitable dimensions sized to correspond to the dimensions of the gypsum layer 12. The first and second cellulose-based layers 14 and 16 can be applied to the gypsum layer 12 by any conventional process.

In order to improve the moldistat and/or bacteristat properties of wallboard, zinc oxide can be incorporated into the gypsum layer 12 and/or at least one cellulose-based layer 14 or 16. The presence of zinc oxide in the gypsum layer 12 and/or at least one cellulous-based layer 14 or 16 is believed to improve the moldistat properties, bacteriastat properties, and/or to reduce spore production by fungus.

In one embodiment, as shown in FIG. 1, zinc oxide particles 18 can be incorporated into at least one cellulose-based layer 14 or 16. The zinc oxide particles 18 can be introduced into the cellulose-based layer pulp mixture used to form a cellulose-based layer that is impregnated with zinc oxide particles. Impregnated zinc oxide particles 18 can be particularly advantageous because they are not readily scraped off the exterior surfaces during the handling of the wallboard 10. The zinc oxide particles 18 can also be coated onto at least one exterior surface 19 of the cellulose-based layer 14 or 16. For example, a suspension of zinc oxide particles in a volatile carrier with optional amounts of other ingredients may be applied to a surface of a cellulose-based layer. After application, all or substantially all of the carrier vaporizes leaving a predominantly zinc oxide layer. Example volatile carriers include water, alcohols and/or solvents. The zinc oxide particles 18 can also be coated onto the exterior surface 19 of the cellulose-based layers 14 and/or 16 after the cellulose-based layer 14 and/or 16 has been applied to the gypsum layer 12. In one embodiment, the zinc oxide particles 18 can be coated onto the cellulose-based layers 14 and 16 by brushing, spraying, dipping and/or rolling at least one exterior surface 19 of the cellulose-based layers 14 or 16. In one embodiment, a fixative, such as a lacquer, can be applied over the zinc oxide particles coated onto the cellulose-based layer 14 and/or 16 to reduce the tendency for zinc oxide particles to be scraped off the surface of the cellulose-based layer 14 or 16 through handling. In another embodiment, a conventional primer can be applied over the external surface 19 of the cellulose-based layer 14 or 16 coated with zinc oxide particles.

In one embodiment, any suitable amount of zinc oxide, which acts as a partial or complete moldistat and/or bacteriastat when incorporated into or coated on the cellulose-based layer 14 or 16, can be used. The amount of zinc oxide impregnated in or coated onto the cellulose-based layer 14 or 16 can be varied depending on the conditions the wallboard will be subjected to. Such conditions include the degree of moisture present, presence of known fungi and/or bacteria in the area, and the expected temperatures. In one embodiment, the amount of zinc oxide in the cellulose-based layer 14 or 16 can comprise from about 1 to about 25 weight percent of the cellulose-based layer 14 or 16. In another embodiment, the amount of zinc oxide in the cellulose-based layer 14 or 16 can comprise from about 10 to about 20 weight percent of the cellulose-based layer 14 or 16.

The zinc oxide particles 18 incorporated into the cellulose-based layer 14 or 16 can have a plurality of morphologies and sizes. In one embodiment, the zinc oxide particles 18 can have a particle size of from about 0.001 to about 10 microns. In another embodiment, the zinc oxide particles 18 can have a particle size of from about 0.01 to about 2 microns. In one embodiment, the zinc oxide particles 18 can have a surface area that is greater than the particle size of zinc oxide particles 18 used in conventional pigments or paints. In one embodiment, the zinc oxide particles 18 can have a specific surface of from about 2 m²/gram to about 100 m²/gram. In another embodiment, the zinc oxide particles 18 can have a specific surface of from about 2.5 m²/gram to about 10 m²/gram. Zinc oxide particles having a greater specific surface typically exhibit increased bacteriastat and moldistat properties. By increasing the specific surface of the zinc oxide particles, more active sites for contacting bacteria and mold are available per unit mass of zinc oxide. Accordingly, zinc oxide particles 18 having increased specific surface improve the bacteriastat and moldistat properties of the cellulose-based layer 14 or 16.

In one embodiment, zinc oxide particles 18 having a relatively high reactivity, such as those made according to the French Process for precipitated oxide defined in the Standard Specification for Zinc Oxide Pigments ASTM Standard D79 and the Standard Classification for Rubber Compounding Materials—Zinc Oxide ASTM D4295, are incorporated into the cellulose-based layer 14 or 16. Unlike the low reactivity zinc oxides, such as those made according to the American Process for post-treated oxides defined in the Standard Specification for Zinc Oxide Pigments ASTM Standard D79 and the Standard Classification for Rubber Compounding Materials—Zinc Oxide ASTM D4295, which are typically used in paint in which a less reactive zinc oxide is desired, zinc oxide particles having a high reactivity can be used in wallboard applications. High reactivity zinc oxide particles have an increased number of active sites that can contact and inhibit bacteria and mold. The reactivity of zinc oxide particles can be increased by increasing the specific surface and/or modifying the surface morphology of the particles.

As shown in FIG. 2, the wallboard 20 can comprise a gypsum layer 22 sandwiched between a first cellulose-based layer 24 and a second cellulose-based layer 26. In this embodiment, the gypsum layer 22 can comprise zinc oxide particles 28. The zinc oxide particles 28 can be introduced into the slurry that forms the gypsum layer 22 to form an impregnated gypsum layer 22. The zinc oxide particles 28 can also be coated onto the exterior surface 29 of the gypsum layer 22 as described above.

In another embodiment, as shown in FIG. 3, the wallboard 30 can comprise a gypsum layer 32 comprising zinc oxide particles 38 either impregnated within, or coated onto an exterior surface 39 of the gypsum layer. The gypsum layer 32 is sandwiched between a first cellulose-based layer 34 and a second cellulose-based layer 36. At least one of the first and second cellulose-based layers 34 and 36 can comprise zinc oxide particles 38 as described above.

### EXAMPLE

A culture of Stachybotrys chartarum was obtained from molded drywall and maintained in test tubes under sterile laboratory conditions. Four identical square wallboard samples having a length and height of 2¼ inches were provided by Horsehead Corp. and designated as samples A, B, C, and D respectively. A spore suspension of Stachybotrys chartarum was sprayed onto each wallboard sample. Sample A was an untreated wallboard samples. The front side and back side of Sample B was sprayed with zinc oxide particles in an aqueous suspension. The front side and back side of Sample C was brushed with a single application of a standard commercially available interior latex primer. The front side and back side of Sample D was brushed with a single application of primer produced by adding zinc oxide particles to the primer used in Sample C.

The front side, corresponding to the exterior side of installed wallboard, and the back side, corresponding to the interior side of installed wallboard, of each sample were sprayed with a spore suspension containing about 100,000 conidia per milliliter and placed in plastic containers to stimulate mold growth. The mold growth procedures employed followed the guidelines as set forth by Price and Ahearn, Current Microbiology 39:21-26 (1999). After six weeks of mold growth, zones of mold growth or mold sporulation inhibition were determined.

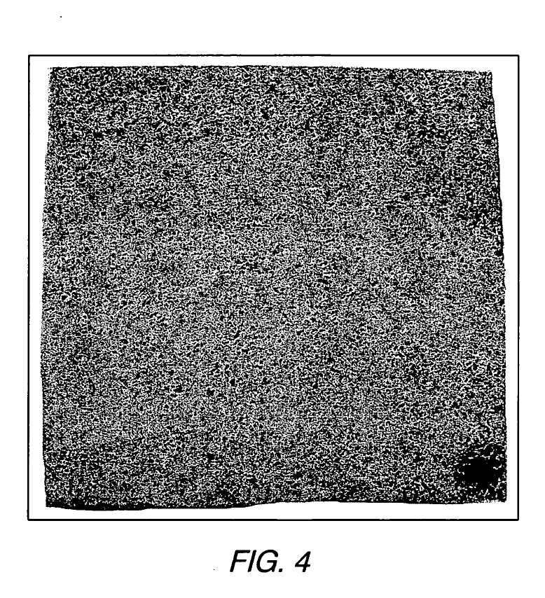

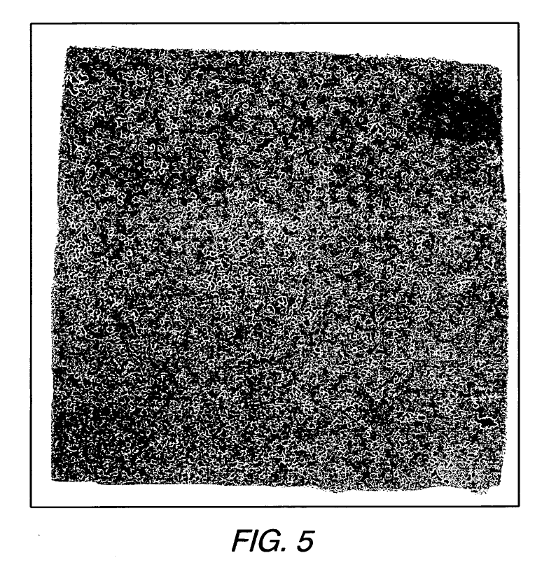

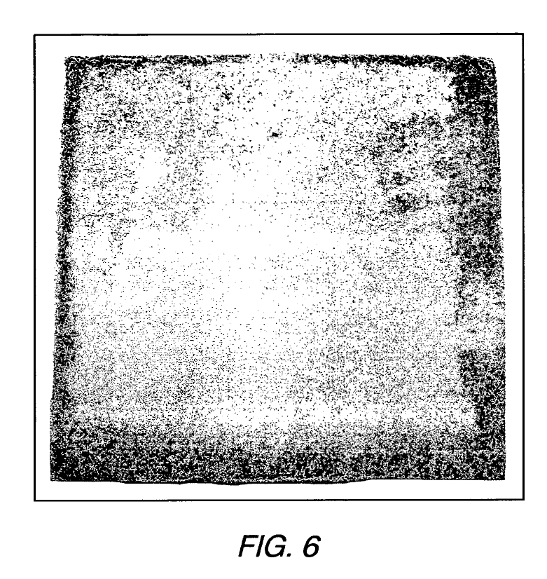

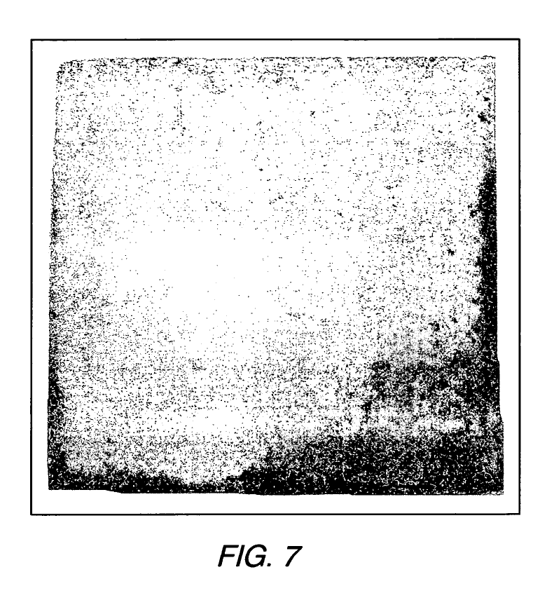

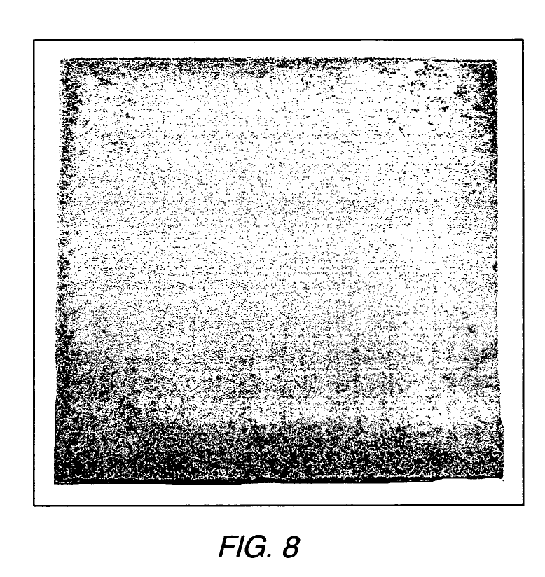

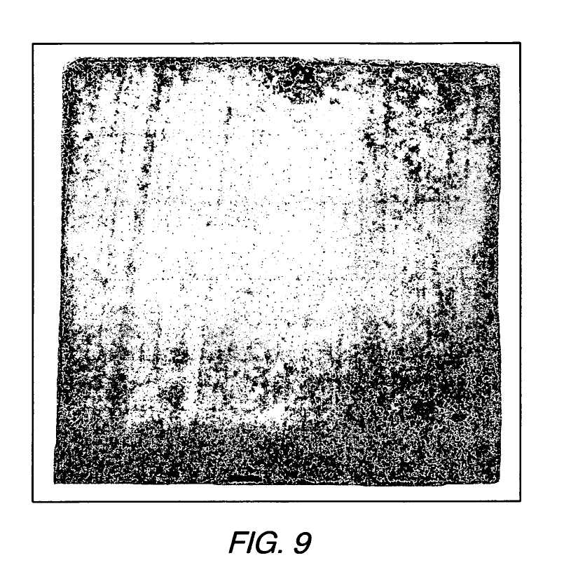

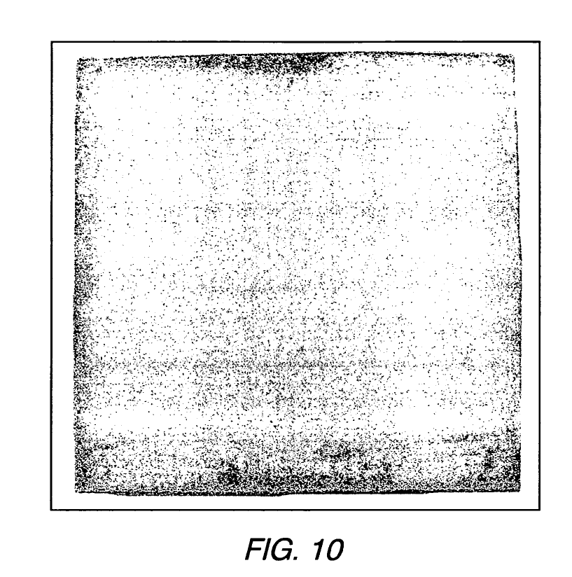

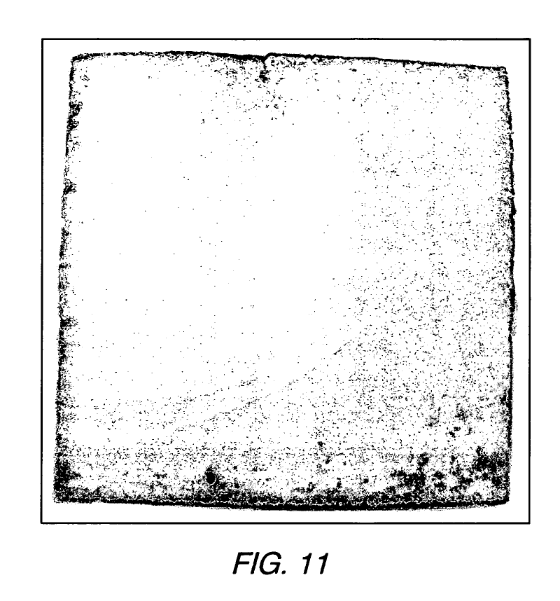

As shown in FIG. 4, the front side of Sample A exhibited extensive growth of Stachybotrys chartarum. Approximately 1130 colonies of Stachybotrys chartarum were observed to have grown on the front side of Sample A. Likewise, as shown in FIG. 5, the back side of Sample A exhibited extensive growth of Stachybotrys chartarum. Approximately 1410 colonies of Stachybotrys chartarum were observed to have grown on the back side of Sample A. As shown in FIG. 6, no colonies of Stachybotrys chartarum were observed on the front side of Sample B. As shown in FIG. 7, only 14 colonies of Stachybotrys chartarum were observed to have grown on the back side of Sample B. As shown in FIG. 8, no colonies of Stachybotrys chartarum were observed on the front side of Sample C. As shown in FIG. 9, 265 colonies of Stachybotrys chartarum were observed on the back side of Sample C. As shown in FIG. 10, no colonies of Stachybotrys chartarum were observed on the front side of Sample D. Likewise, as shown in FIG. 11, no colonies of Stachybotrys chartarum were observed on the back side of Sample D. Accordingly, Sample B coated with zinc oxide particles in aqueous solution exhibited improved moldistat properties over the untreated wallboard Sample A and the wallboard Sample C treated only with a conventional primer. Likewise Sample D coated with zinc oxide particles and conventional primer exhibited improved moldistat properties over the untreated wallboard Sample A and the wallboard Sample C treated only with a conventional primer.

Whereas particular embodiments of this invention have been described above for purposes of illustration, it will be evident to those skilled in the art that numerous variations of the details of the present invention may be made without departing from the invention as defined in the appended claims.

What is claimed is:

1. Wallboard comprising:
a gypsum layer; and
a cellulose-based layer comprising zinc oxide covering at least a portion of a surface of the gypsum layer.

2. The wallboard of claim 1, wherein the zinc oxide comprises from 1 to 25 weight percent of the cellulose-based layer.

3. The wallboard of claim 1, wherein the zinc oxide comprises from 2 to 10 weight percent of the cellulose-based layer.

4. The wallboard of claim 1, wherein the cellulose-based layer is impregnated with the zinc oxide.

5. The wallboard of claim 1, wherein the zinc oxide is coated on a surface of the cellulose-based layer.

6. The wallboard of claim 1, wherein the zinc oxide has a particle size of from 0.001 microns to 10 microns.

7. The wallboard of claim 1, wherein the zinc oxide has a particle size of from 0.1 microns to 2 microns.

8. The wallboard of claim 1, wherein the zinc oxide has a specific surface of from 2 m²/gram to 100 m²/gram.

9. The wallboard of claim 1, wherein the zinc oxide has a specific surface of from 2 m²/gram to 10 m²/gram.

10. The wallboard of claim 1, wherein the gypsum layer comprises zinc oxide.

11. The wallboard of claim 1, wherein the cellulose-based layer comprises paper, kraft paper, cardboard and/or fiberglass.

12. The wallboard of claim 1, wherein the gypsum layer comprises chemical bonding agents, polymeric fibers, cellulose-based fibers and/or metal fibers.

13. The wallboard of claim 1, further comprising another cellulose-based layer comprising zinc oxide covering at least a portion of another surface of the gypsum layer.

14. Wallboard comprising a gypsum layer comprising zinc oxide.

15. The wallboard of claim 14, wherein the gypsum layer is impregnated with the zinc oxide.

16. The wallboard of claim 14, wherein the zinc oxide is coated on a surface of the gypsum layer.

17. The wallboard of claim 14, further comprising at least one cellulose-based layer covering at least one surface of the gypsum layer.

18. The wallboard of claim 17, wherein the cellulose-based layer comprises zinc oxide.

19. A method of making gypsum wallboard, comprising:
incorporating zinc oxide particles having a surface area of from 2 m²/gram to 100 m²/gram with a cellulose-based layer; and
applying the cellulose-based layer over at least a portion of an outer surface of a gypsum layer.

20. The method of claim 19, wherein incorporating the zinc oxide comprises, brushing, spraying, dipping and/or rolling a surface of the cellulose-based layer.

21. The method of claim 19, wherein incorporating the zinc oxide comprises impregnating the cellulose-based layer with the zinc oxide particles.

22. A method of making gypsum wallboard, comprising:
incorporating zinc oxide particles having a specific surface of from 2 m²/gram to 100 m²/gram with a gypsum layer material.

23. The method of claim 22, further comprising applying a cellulose-based layer over at least a portion of an outer surface of a gypsum layer material.
